(19) United States
(12) Patent Application Publication
(10) Pub. No.: US 2018/0126568 A1
(43) Pub. Date: May 10, 2018

(54) Knife

(71) Applicant: Landon Elliott Christensen, Lehi, UT (US)

(72) Inventor: Landon Elliott Christensen, Lehi, UT (US)

(21) Appl. No.: 15/729,673

(22) Filed: Oct. 11, 2017

Related U.S. Application Data
(60) Provisional application No. 62/407,996, filed on Oct. 13, 2016.

(51) Int. Cl. B26B 9/02; B25G 1/10

(52) U.S. Cl. CPC B26B 9/02; B25G 1/102

(57) ABSTRACT

A knife is provided. The knife includes an ergonomic handle having a center axis. The knife includes a blade extending from the handle, wherein the blade has a tip with a rounded shape. The rounded shape of the tip is positioned in a central position with respect to the handle. The tip can be a circular shape have its center aligned with the center axis of the handle. The blade may have a blade edge that has a convex shape that extends beyond a line that contacts a furthermost point of the handle from the center axis and extends in parallel with the center axis. The blade may have a uniform thickness from its spine to its blade edge.

### CROSS REFERENCE TO RELATED APPLICATION(S)

This application claims the benefit of U.S. Provisional Patent Application No. 62/407,998, filed Oct. 13, 2016 and U.S. Provisional Patent Application No. 62/406,386, filed Oct. 10, 2016, the disclosures of which are hereby incorporated entirely herein by reference.

### BACKGROUND

### Technical Field

The present disclosure relates to flatware, and more particularly, to cutlery such as knives.

### State of the Art

A knife is a tool with a cutting edge or blade. There are many types of knives, such as those used in the kitchen (i.e., paring knife, carving knife, and/or chef's knife), those used in the dining room (i.e., butter knife and/or steak knife), or those used as tools or weapons (i.e., pocket knife, scalpel, switchblade, and/or hunting knife). Many of these knives have been sized and shaped for a particular purpose.

Knives are often used in food preparation, as suggested above. Some modern-day food items used in food preparation may come pre-packaged in containers or bottles. In some cases, the removal of the food can be difficult.

In view of the foregoing, it would therefore be advantageous to food preparers the world over to have a knife-type utensil that addresses these concerns.

### SUMMARY

The present disclosure relates to flatware, and more particularly, to cutlery, even a type of knife for food preparation applications.

An aspect of the present disclosure includes a knife comprising: a handle having a center axis; a blade extending from the handle; a tip of the blade positioned away from the handle, wherein the tip of the blade has a rounded shape whose center is positioned proximately along the center axis of the handle.

Another aspect of the present disclosure includes wherein the tip is a circular shape having a center positioned proximate the line defined by the center axis of the handle.

Another aspect of the present disclosure includes wherein the blade has a spine and an opposing edge, and wherein the opposing edge has a convex shape that extends beyond a line that contacts a furthermost point of the handle from the center axis and extends in parallel with the center axis.

Another aspect of the present disclosure includes wherein the circular shape of the tip has a perimeter within a first line that contacts a furthermost point of the handle from the center axis in a first direction parallel with the vertical orientation of the blade and extends in parallel with the center axis and a second line that contacts a furthermost point of the handle from the center axis in a second direction opposite the first direction and extends in parallel with the center axis.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a side perspective view of an embodiment of a knife in accordance with the present disclosure;

FIG. 2 is a side view of an embodiment of a knife in accordance with the present disclosure;

FIG. 3 is a bottom view of an embodiment of a knife in accordance with the present disclosure;

FIG. 4 is a top view of an embodiment of a knife in accordance with the present disclosure;

FIG. 5 is a front view of an embodiment of a knife in accordance with the present disclosure;

FIG. 6 is a rear view of an embodiment of a knife in accordance with the present disclosure;

FIG. 7 is a side view of an embodiment of a container in accordance with the present disclosure; and

FIG. 8 is a side view of an embodiment of a knife in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

The drawings depict illustrative embodiments of a knife 10. These embodiments may each comprise various structural and functional components that complement one another to provide the unique functionality and performance of the knife 10, the structure and function of which will be described in greater detail herein. For example, embodiments of the knife 10 may comprise a handle 20 and a blade 40, among other components to be described herein.

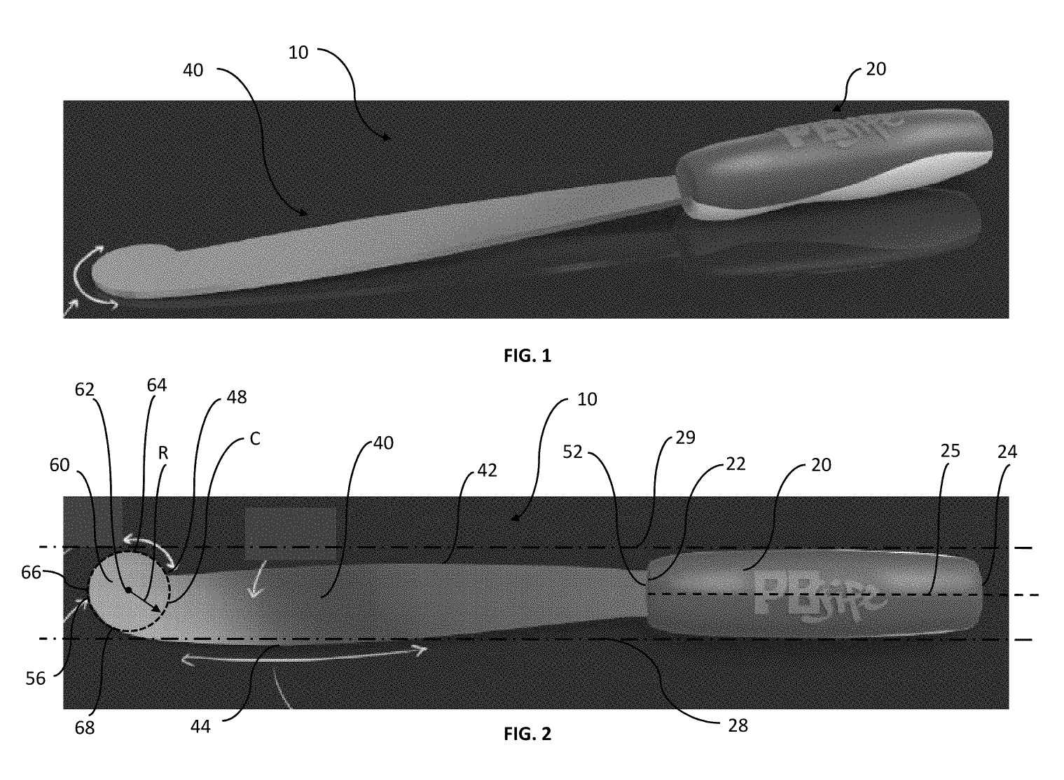

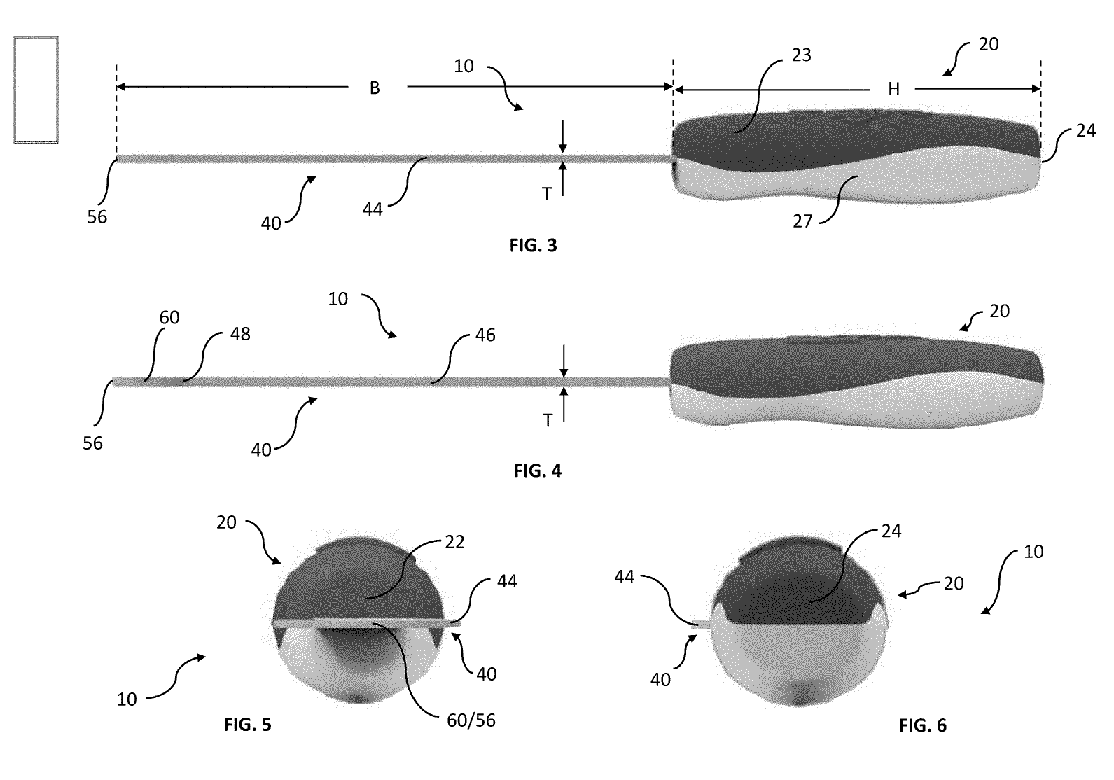

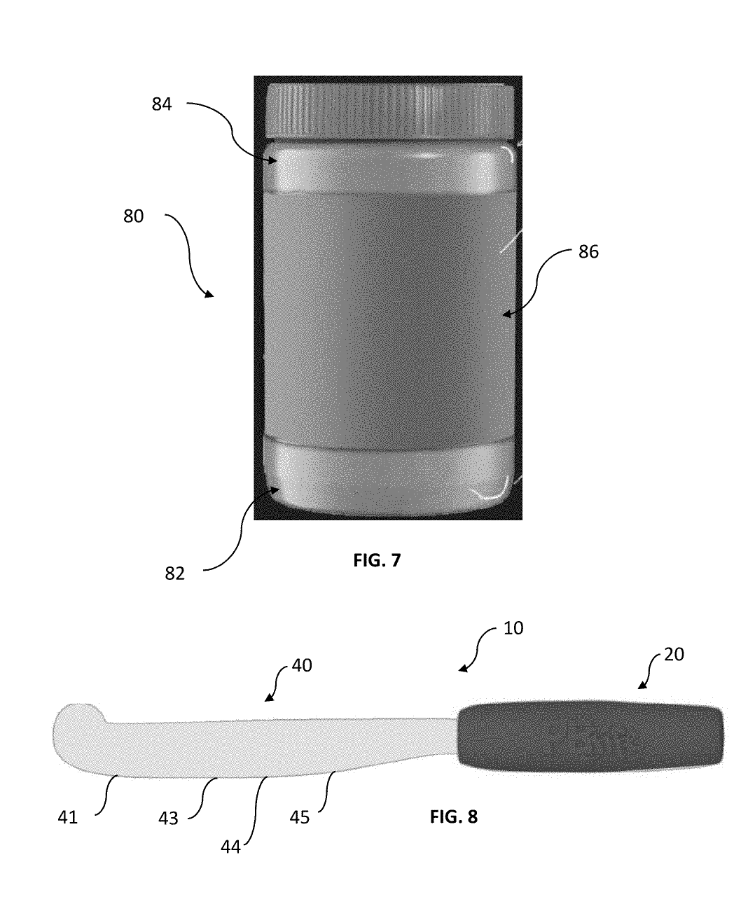

Referring to the drawings, FIGS. 1-4 depict a knife 10. Embodiments of the knife 10 may comprise a handle 20. The handle 20 may further comprise a first end 22 and a second end 24. The first end 22 may be configured to be coupled to the blade 40. Embodiments of the knife 10 may comprise the handle 20 being releasably coupled to the blade 40. Alternatively, the handle 20 may be integral with the blade 40. Further in the alternative, the handle 20 may be molded, connected, formed, cast, created, or otherwise fashioned about a portion of the blade 40, such that the handle 20 overlaps a portion of the blade 40 and the blade 40 extends from the handle 20 at the first end 22. Embodiments of the knife 10 may comprise the first end 22 having a thickness, radius, or size that is greater than the thickness, radius, or size of the blade 40 at the point the blade 40 couples to the first end 22. Embodiments of the knife 10 may comprise the second end 24 being configured as a butt or pommel end or a handle head of the knife 10.

Embodiments of the knife 10 may comprise the handle 20 having an ergonomic shape, wherein the shape of the handle 20 is configured to be gripped by a user to manipulate the blade 40 attached thereto. For example, the handle 20 may have a length H between the first end 22 and the second end 22. The handle 20 may also have a generally cylindrical or tubular shape about a central axis 25, the central axis 25 running substantially parallel with the length H, and vice versa. The handle 20 may further comprise a first portion 23 and a second portion 27. The first portion 23 may oppose the second portion 27 on the handle 20, yet the first portion 23 and the second portion 27 may complement and/or balance one another as parts of the handle 20. The first portion 23 may have a curved, bent, bowed, convex, arched, or otherwise rounded exterior surface. The second portion 27 may have an undulating, rolling, concave, swelling, rippling, curvy, or otherwise wavy exterior surface. The first and second portions 23 and 27 may serve to assist the user to gain a grip on the handle 20, such that the handle 20 may not slip through the user's grip during the use of the knife 10.

Embodiments of the knife 10 may comprise a blade 40. The blade 40 may comprise a first end 52 and a second end 56. The first end 52 may be configured to be coupled to the handle 20. Embodiments of the knife 10 may comprise the blade 40 being releasably coupled to the handle 20. Alternatively, the blade 40 may be integral with the handle 20. Further in the alternative, the handle 20 may be molded, connected, formed, cast, created, or otherwise fashioned about a portion of the blade 40, such that the handle 20 overlaps a portion of the blade 40 and the blade 40 extends from the handle 20 at the first end 22 of the handle 20. In this way, the knife 10 may be configured such that the first end 52 of the blade 40 is positioned proximate, or abuts, the first end 22 of the handle 20.

Embodiments of the knife 10 may comprise the blade 40 having a length B between the first end 52 and the second end 56. The length B of the blade 40 may configured to have a length sufficient to permit the blade 40 to be inserted within a container 80 and reach the bottom corners 82 of the container 80 without any portion of the handle 20 having to be inserted within the container 80. As such, the length B may be a predetermined length based on the size of the container 80. For example, the length B may be at least twice as long as the length H of the handle 20. Alternatively, the length B may be at least twice as long but less than three times as long as the length H of the handle 20. Further in the alternative, the length B may be at least as long as the length H but less than twice the length H. Further still, the length B may be at least three times as long as the length H. Accordingly, the knife 10 may be configured during manufacturing to be a predetermined length to correspond to a length (or height) of any container 80, such as a peanut butter jar, a jam jar, a mayonnaise jar, an apple sauce jar, or any other container 80 having a paste and/or thick sauce or liquid contained therein.

Embodiments of the knife 10 may comprise the blade 40 having a spine 42 opposing a blade edge 44. The spine 42 of the blade 40 may be configured to run the length of the blade 40 from the first end 52 to the second end 56. Embodiments of the knife 10 may comprise the spine 42 remaining below, or not extending beyond, a line 29 that contacts the upper-most point of the handle 20 and runs substantially parallel with the central axis 25 of the handle 20 when viewed in side profile, as depicted in FIG. 2. The spine 42 may be configured to have a straight or planar surface. Alternatively, the spine 42 may have somewhat of a convex shape or surface, wherein the spine 42 may exhibit a slight bend, bow, or arch between the first end 52 and the second end 56. The spine 42 may terminate near the second end 56 at a point 48. Embodiments of the knife may comprise the blade edge 44 being configured to run the length of the blade 40 from the first end 52 to the second end 56. The blade edge 44 may be configured to have a straight or planar surface. Alternatively, the blade edge 44 may have somewhat of a convex shape or surface, wherein the blade edge 44 may exhibit a bend, bow, or arch between the first end 52 and the second end 56. For example, the convex shape, or bowed shape, of the blade edge 44 may provide that the blade edge 44 has a substantially convex shape from the first end 52 to the second end 56. In other words, the configuration of the blade edge 44 may be such that the blade edge 44 bows from substantially the first end 52 to substantially the second end 56.

Further, embodiments of the knife 10 may comprise at least a portion of the blade edge 44 extending below, or beyond, a line 28 that contacts the lower-most point of the handle 20 and runs substantially parallel with the central axis 25 of the handle 20 when viewed in side profile, as depicted in FIG. 2. Such a configuration, may allow the blade 40 to be broad enough (i.e., wide enough) between the spine 42 and the blade edge 44 to collect thereon large quantities of contents within the container 80. Moreover, with the blade edge 44 extending beyond the line 28 and having a slight convex shape, the blade edge 44 may conveniently and efficiently scrape a side surface of the container 80 to thereby collect the contents of the container 80 from off its sidewall 86. Embodiments of the knife 10 may further comprise the blade edge 44 having a straight or planar section 43 between opposing convex sections 41 and 45, such that the straight section 43 may contact the sidewall 86 of the container and scrape the contents therefrom as the blade 40 is moved within the container 80. In other words, and as depicted in FIG. 8, the blade edge 44 may comprise a first convex or arched section 45 from the first end 52 to the central straight section 43 and a second convex or arched section 41 from the second end 56 to the central straight section 43. In this way, a portion (i.e., central straight section 43) of the blade edge 44 is flat, planar, or otherwise straight.

Embodiments of the knife 10 may further comprise the blade 40 having a thickness T. The blade 40 may have a thickness T to allow the blade 40 to have some flexibility but resist bending. For example, the blade 40 may be configured to have a thickness T that provides for elastic deformation without plastic deformation. Further, the thickness T may be uniform across the blade 40. For example, the blade 40 may have the same thickness T from the first end 52 to the second end 56 and from the spine 42 to the blade edge 44. In other words, unlike a conventional knife that may have a reduced thickness to create a sharp cutting edge, the knife 10 may have a uniform thickness across the entire blade 40.

Embodiments of the knife 10 may comprise a tip 60. The tip 60 may be configured on the blade 40 proximate the second end 56. The tip 60 may be configured of a size and shape to permit the convenient and efficient removal of contents from the bottom corners 82 and the top corners 84 of the container 80 by using the tip 60. For example, the tip 60 may be inserted into the container 80 and used to scrape or collect contents thereof from corners 82 and 84. Embodiments of the knife 10 may comprise the tip 60 being configured in a rounded shape, such as a circle, an ellipse, or other similar rounded-edge shape. As depicted, the tip 60 may be of circular shape C and have a radius of curvature R from a center point 62.

Embodiments of the knife 10 may comprise the center point 62 being configured proximately between the lines 28 and 29, and the radius of curvature R may be of a size such that the perimeter of the circular shape C of the tip 60 does not extend beyond the lines 28 and 29. In other words, the center point 62 may be centered proximately the center axis 25 of the handle 20, should the center axis 25 be extended along the length of the blade 40. In this way, the operative end of the blade 40—the tip 60—may be proximately centered with the handle 20 for balance and ease of manipulation by the user. With the tip 60 configured in a circular shape, the tip 60 may comprise a first rounded surface 64, a second rounded surface 66, and a third rounded surface 68. The first rounded surface 64 may be configured between the point 48, where the spine 42 contacts the curvature of the tip 60 or the perimeter edge of the circular shape C, and the second end 56 of the blade. The first rounded surface may be opposite that of the blade edge 44. The second rounded surface 66 may be configured at the second end 56 of the blade 40. The second rounded surface 66 may be opposed to the handle 20, such that the second rounded surface is the very tip of the blade 40 opposite the handle 20. The third rounded surface 68 may be in opposition to the first rounded surface 64 and may comprise a plurality of curves. For example, the third rounded surface 68 may have a first radius of curvature R1 from the radius of curvature R of the tip 60 and a second radius of curvature R2 from the radius of curvature of the bend or arch of the blade edge 44. As such, the third rounded surface 68 may have a prolonged or longer curved edge than either of the first rounded surface 64 or the second rounded surface 66. Indeed, the third rounded surface 68 may flow into the curvature of the blade edge 44.

Embodiments of the knife 10 may comprise the first rounded surface 64 being configured to reach under the upper corners 82 of the container 80. For example, the first rounded surface 64 of the tip 60 may be defined between the second end 56 and the point 48. The point 48 may be an abrupt change in geometry where the rounded tip 60 meets the relatively straight or slightly arched spine 42. Such an abrupt change in shape, however, may permit the first rounded surface 64 to reach under or extend under the upper corners 82 of the container 80 to collect the contents therein.

Embodiments of the knife 10 may comprise the tip 60 having a radius of curvature R with a size sufficient to permit the perimeter edges of the circular shape C to protrude or extend beyond the lines 28 and 29. Indeed, the size of the tip 60 may be enlarged or reduced, at the time of manufacture, depending on size and shape of the container 80 and in particular the size and shape of the corners 82 and 84.

Embodiments of the knife 10 may comprise the blade 40 and the handle 20 having no guard, bolster, or finger guard positioned between the blade 40 and the handle 20. Without a guard the knife 10 may be better positioned within the container 80. For example, the blade 40 may be inserted within the container 80 up to the point where the tip 60 may contact the bottom of the container 80 or the bottom corners 84, without any guard obstructing such insertion. Thereafter, the user may manipulate the handle 20 to angle the blade 40, and, in particular, the blade edge 44 and the tip 60, to collect the contents of the container 80. In many cases, the knife 10 may be configured to allow the user to collect the difficult-to-reach contents of the container 80 that may otherwise be impossible to reach with conventional utensils.

Embodiments of the knife 10 may comprise the handle 20 and the blade 40 being manufactured from materials that provide sufficient strength to allow the handle 20 and the blade 40 to function as described herein. For example, embodiments of the knife 10 may comprise the handle 20 and/or the blade 40 being manufactured of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described knife 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components, for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A knife comprising:
a handle having a center axis;
a blade extending from the handle;
a tip of the blade positioned away from the handle, wherein the tip of the blade has a rounded shape whose center is positioned proximately along the center axis of the handle.

2. The knife of claim 1, wherein the tip is a circular shape having a center positioned proximate the line defined by the center axis of the handle.

3. The knife of claim 1, wherein the blade has a spine and an opposing edge, and wherein the opposing edge has a convex shape that extends beyond a line that contacts a furthermost point of the handle from the center axis and extends in parallel with the center axis.

4. The knife of claim 2, wherein the circular shape of the tip has a perimeter within a first line that contacts a furthermost point of the handle from the center axis in a first direction parallel with the vertical orientation of the blade and extends in parallel with the center axis and a second line that contacts a furthermost point of the handle from the center axis in a second direction opposite the first direction and extends in parallel with the center axis.
